(19) United States
(12) Patent Application Publication
(10) Pub. No.: US 2006/0155916 A1
(43) Pub. Date: Jul. 13, 2006

(54) Writing uncorrupted data to electronic memory

(76) Inventors: Carl L. Gilbert, Southfield, MI (US); Magda Hakim, Northville, MI (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 11/032,770

(22) Filed: Jan. 11, 2005

(51) Int. Cl. G06F 12/00

(52) U.S. Cl. 711/103

(57) ABSTRACT

A write mode for programming selected memory locations of an electronic module with data includes writing data to be programmed into memory into first, second and third data blocks, and a checksum corresponding to data block. A read mode for reading and using data located in memory locations includes reading data from first, second, and third data blocks, determining if the contents of those data blocks is identical to the contents of any other of the data blocks, and using the data from the memory with the contents of any data block whose contents are identical to the contents of another data block.

### BACKGROUND OF THE INVENTION

The present invention relates generally to non-volatile electronic memory, and more particularly to a technique for writing data reliably into memory cells on an integrated circuit chip.

When writing and storing data in non-volatile electronic storage devices such as EEPROM and ROM, before writing the new data into memory the existing contents of at least the subject memory position must first be erased, an intermediate process step called erasure. If a failure occurs between the erasure step and the subsequent write step, the new data as well as the old data will be lost.

Programming of EEPROMs is quite time consuming in comparison to other memory types. For example, in random access memories, the time to perform a write is about the same as the time required to perform a read. In the case of EEPROMs, a typical write time might be over four orders of magnitude longer to write than a typical read time. An approximate 3 ms write time is required for each byte that is to be programmed. Consequently, the write time becomes even greater if a large number of bytes are to be programmed. Included in the time to write is the time to erase and to program.

Various strategies have been attempted to avoid corrupted data during the erasure and writing steps. For example U.S. Pat. No. 4,763,305 describes a memory having a byte program mode, which avoids unnecessary erase and program cycles. If a byte is to be programmed, the new data to be written is first compared to the existing data in the byte. If the old data is the same as the new data, there is no need to do a conventional erasure program cycle. In such case, the memory does not perform the erasure step and reprogram, thereby saving time and avoiding a decrease in the life of a floating gate transistors in the byte. If the old data is not the same as the new data, the byte may already be in the erased state. In such case, the erasure step is skipped and programming is begun. The method ensures that a set of writes to EEPROM completes successfully, or that each affected memory location is returned to its prior value without ever becoming corrupted.

To avoid corruption or loss of data, it is now conventional practice to minimize the time involved in storing new data in the memory storage device. There is a need, however, to eliminate time as a factor in reliably writing data to an electronic memory or other storage device. There is need for a write mode process that ensures that uncorrupted data is written to memory despite the occurrence of a failure at any time during the data write and erasures steps without making the newly written data meaningless.

### SUMMARY OF THE INVENTION

The present invention provides a method for storing data with a memory device that functions with the general properties and characteristics of EEPROM without resulting in data corruption due to failures that may occur while writing data to the device. The process eliminates the duration of the write and erasures steps as factors in reliably writing data to an electronic data storage device.

In realizing these and other advantages, the present invention includes a write mode for programming a selected memory location with data in a memory having memory locations. Data to be programmed into memory is first written into first, second and third data blocks. Periodically checksums of the first, second and third data blocks are evaluated. The memory is programmed with the contents of a data block that contains valid data as indicated by a checksums evaluation. If checksums fails to indicate valid data is present, a check is made to determine whether the contents of any of the first, second, and third data blocks is identical to the contents of any other of the data blocks. The memory is programmed with the contents of any data block whose contents are identical to the contents of another data block.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic diagram of a three blocks of memory for use in accordance with the present invention; and

FIGS. 2A and 2B together are a flow diagram of the method implemented by the preferred embodiment of the invention.

### DESCRIPTION OF THE PREFERRED EMBODIMENT

Data stored on ROM chips is nonvolatile, i.e., the contents of electronic memory is not lost when its electric power source is removed. The chips contain a grid of columns and rows, whose intersections are memory locations where data bits are stored. An electric charge can be conducted down a column with the selected row grounded to connect at a specific cell. The cell will be read a “on “or “off” depending on whether a connection is made to ground through the cell.

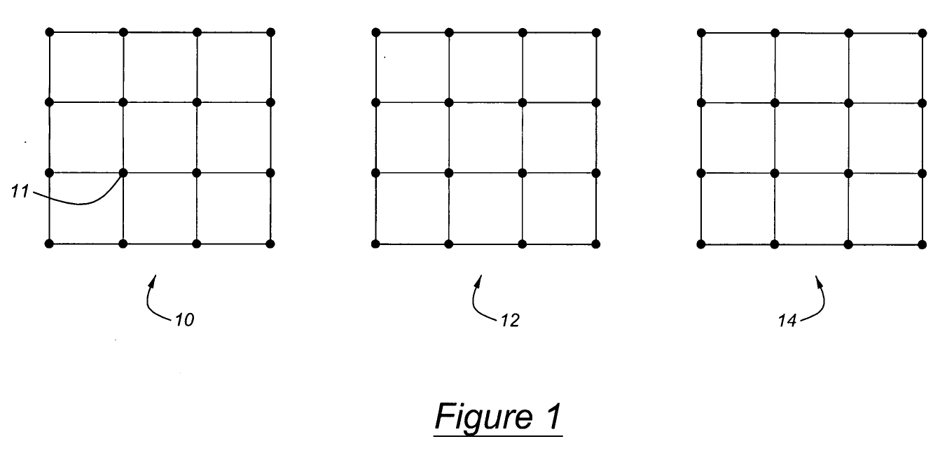

Referring first to FIG. 1, a main data block 10 of electronic memory contains multiple bytes arranged in memory locations. First and second storage locations or backup data blocks 12, 14 of electronic memory also contain multiple bytes arranged in memory locations. The current contents of at least one memory location 11 is to be changed by erasing its contents and reprogramming or writing new data into a selected memory location 11.

It is conventional practice to change the contents of multiple bytes of data in main block 10 one byte at a time. For example, the existing value in a selected or target memory location in block 10 is “0×1234” in hexadecimal format. It is desired to write to this location a new value “0×ABCD” also in hexadecimal format. On a given architecture, this could take two operations to change the two bytes in the selected memory location. The first operation writes “0×AB”. The second operation writes “0×CD”. If a failure occurs between the first and second operations, the selected memory location would contain the value “0×AB34”. But this value is corrupt and does not represent the former value or the intended value.

Checksums is an algorithm, which is applied to the entire contents of a block of memory to determine whether the block contains corrupted data. If the checksum output produces a “0” in the terminal output bit, the data in the block is valid; if the checksum output produces a “1” in the terminal bit, the data in the block is invalid. During the write mode steps of this invention, checksums is written and data to be entered in memory and used is written.

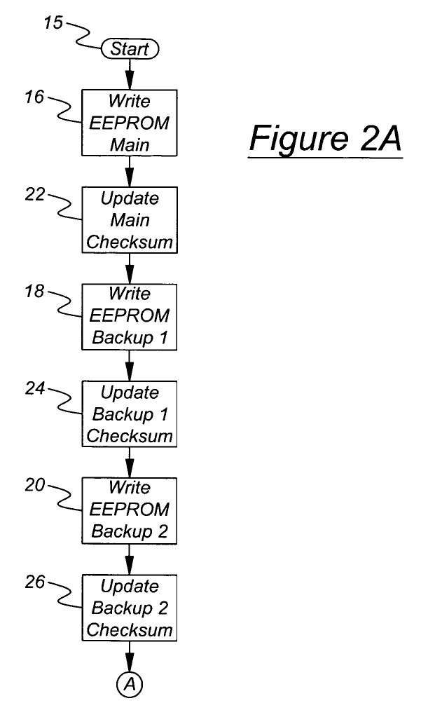

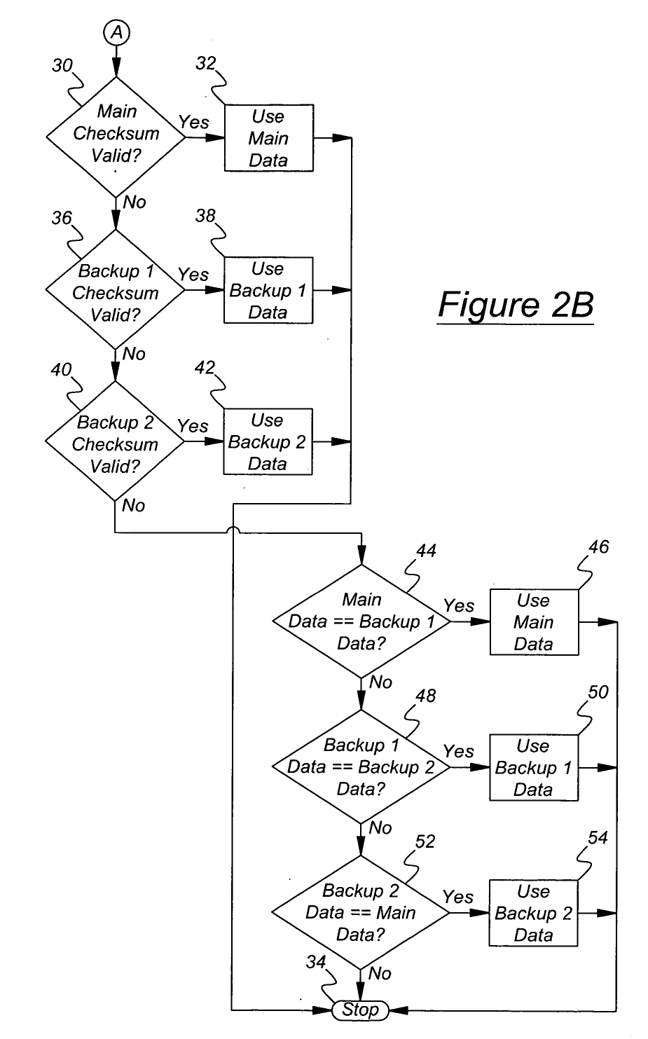

However, knowing the data is invalid may not be enough to allow the module to operate successfully. For example, before the data value in a memory location can be changed, a password must be known. But if the password is corrupted, the corresponding data value becomes unavailable. For security reasons, all future access to the module may be completely denied, handicapping use of the module. For example, an automobile keyfob is a device that has stored within its electronic memory a coded password required to open the door locks. That password can be stored in memory using the procedure described with reference to FIG. 2A. The coded password is required each time a button on the keyfob is pushed to open the door locks. Each time that button is pushed, the keyfob reads the coded data corresponding to the password, validates it, and uses it to actuate the door locks. Reading and validating the data is performed in accordance to the procedural steps described with reference to FIG. 2B.

Turning now to FIG. 2A, the method steps of this invention for writing data to electronic memory start at step 15. At step 16, the new data value, such as a coded password, is written, preferably serially, to the main data block 10. At step 18, the new data value is written to the first backup data block 12. At step 20, the new data value is written to the second backup data block 14.

At step 22, checksums for the main data block 10 is updated by writing the new data value to checksums for the main data block 10. At step 24, checksums for the first backup block 12 is updated by writing the new data value to checksums for the first backup data block. At step 26, checksums for the second backup block 14 is updated by writing the new data value to checksums for the second backup data block.

The method steps of this invention for reading data to electronic memory and using the data begin at step 30. Checksums is evaluated at step 30 for main block 10, at step 36 for the first backup block 12, and at step 40 for the second backup block 14. If at step 30 the checksums evaluation of main block 10 indicates the data there is valid, control passes to step 32 where the data in the main 10 is used. The read mode to the selected memory location is concluded at step 34. If, however, at step 30 the checksums evaluation of main block 10 indicates corrupt data is present there, control passes to step 36 to determine whether the first backup block 12 contains corrupt data.

If at step 36 the checksums evaluation of first backup block 12 indicates the data there is valid, control passes to step 38 where the data in first backup block 12 is used. The read mode to the selected memory location is concluded at step 34 following step 38. If at step 36 the checksums evaluation of the first backup block 12 indicates corrupt data is present, control passes to step 40 to determine whether second backup block 14 contains corrupt data.

If at step 40 the checksums evaluation of second backup block 14 indicates the data there is valid, control passes to step 42 where the data in second backup block 14 is used. The read mode to the selected memory location is concluded at step 34 following step 42.

If the checksums evaluations of the main block 10 and the two backup blocks 12, 14 indicates the data in each of them is invalid, control passes to step 44, where the data in the main block 10 is compared to data in the first backup block 12. If compare step 44 is logically true, then control passes to step 46 where the data in the main block 10 used, and the read mode to the selected memory location is concluded at step 34.

If the result of compare step 44 is logically false, control passes to step 48 where the data in second backup block 14 is compared to data in the first backup block 12. If compare step 48 is logically true, then control passes to step 50 where the data in the first backup block 12 is used. The read mode to the selected memory location is concluded at step 34.

If compare step 48 is logically false, control passes to step 52 where the data in second backup block 14 is compared to data in the main block 10. If compare step 52 is logically true, then control passes to step 54 where the data in the second backup block 14 used. The write mode to the selected memory location is concluded at step 34 following execution of step 54. If, however, compare step 52 is logically false, the read mode to the target memory location is concluded directly at step 34.

Therefore, if the checksums evaluation of at least two data blocks indicates synonymous data is present there, though their checksums indicate the data there is invalid, the data values of these blocks is used.

Although the write mode steps 15-26 are performed before the read mode steps 30-54, the write mode steps may be repeated often before the read mode steps are required to be executed. Similarly, the read mode steps 30-54 may be repeated often before the write mode steps 15-26 are performed a second time. For example, an automobile keyfob is a device that has stored within it a secret code required to open the door locks. That code can be stored using the procedure described with reference to FIG. 2A. The code is required each time a button on the keyfob is pushed to open the door locks. Each time that button, is pushed the keyfob reads the data, validates it, and uses it to actuate the door locks. Reading and validating the data is performed in accordance to the procedural steps described with reference to FIG. 2B.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. In an electronic device that includes memory locations for containing data, a read-write mode for programming a selected memory location with data, comprising the steps of:
reading data to be programmed into memory into first, second and third data blocks;
periodically evaluating the checksums of the first, second and third data blocks;
if the checksums evaluation indicates that any of the first, second or third data blocks contain valid data, using the contents of any of the first, second and third data blocks;
if the checksums evaluation indicates that none of the first, second or third data blocks contain valid data, determining if the contents of any of the first, second and third data blocks is identical to the contents of any other of the data blocks; and
using the contents of any data block whose contents are identical to the contents of another data block.

2. In an electronic memory including memory locations for containing data, a read-write mode for programming a selected memory location with data, comprising the steps of:
reading data to be programmed into memory into first, second and third data blocks;
periodically evaluating the checksums of the first, second and third data blocks; and
if the checksums evaluation indicates that any of the first, second or third data blocks contain valid data, programming the memory with the contents of a data block that contains valid data.

3. The read-write mode of claim 2 further comprising:
comparing the contents of the first data block to the contents of the second data block;
comparing the contents of the second data block to the contents of the third data block; and
comparing the contents of the first data block to the contents of the third data block.

4. The read-write mode of claim 2, further comprising:
determining that the checksums evaluation indicates that none of the first, second or third data blocks contain valid data;
comparing the contents of the first data block to the contents of the second data block;
comparing the contents of the second data block to the contents of the third data block; and
comparing the contents of the first data block to the contents of the third data block.

5. The read-write mode of claim 2, further comprising:
determining that the checksums evaluation indicates that none of the first, second or third data blocks contain valid data;
comparing the contents of the first data block to the contents of the second data block;
comparing the contents of the second data block to the contents of the third data block;
comparing the contents of the first data block to the contents of the third data block; and
programming the memory with the contents of any data block whose contents are identical to the contents of another data block.

6. The read-write mode of claim 2 further comprising:
determining that the checksums evaluation indicates that none of the first, second or third data blocks contain valid data;
comparing the contents of the first data block to the contents of the second data block;
comparing the contents of the second data block to the contents of the third data block;
comparing the contents of the first data block to the contents of the third data block; and
using the contents of any data block whose contents are identical to the contents of another data block.
